(19) United States
(12) Patent Application Publication
(10) Pub. No.: US 2018/0285933 A1
(43) Pub. Date: Oct. 4, 2018

(54) FACILITATING COLLABORATION BETWEEN ENTITIES BASED ON SIMILARITY IN RESPECTIVE AUDIENCES OF THE ENTITIES

(71) Applicant: Google Inc., Mountain View, CA (US)

(72) Inventors: Jeffrey Lee-Chan, Venice, CA (US); Justin Lewis, Marina del Rey, CA (US)

(21) Appl. No.: 14/667,189

(22) Filed: Mar. 24, 2015

Related U.S. Application Data
(60) Provisional application No. 61/972,876, filed on Mar. 31, 2014.

(51) Int. Cl. G06Q 30/02; H04L 29/06

(52) U.S. Cl. CPC G06Q 30/0269; H04L 67/42

(57) ABSTRACT

Systems and methods that facilitate collaboration between entities based on similarity in respective audiences of the entities, are provided. In an aspect, a system includes an identification component configured to identify a set of channels having at least one common subscriber to a channel, and a ranking component configured to rank respective channels in the set based on number of common subscribers between the respective channels in the set and the first channel. The system further includes a filter component configured to identify a subset of the respective channels in the set based on the ranking, and a recommendation component configured to recommend the subset of the respective channels to an entity associated with ownership of the channel for potential collaboration with the channel.

### RELATED APPLICATION

This application claims priority to U.S. Provisional Patent Application No. 61/972,876 filed on Mar. 31, 2014, and entitled “FACILITATING COLLABORATION BETWEEN ENTITIES BASED ON SIMILARITY IN RESPECTIVE AUDIENCES OF THE ENTITIES.” The entirety of the aforementioned application is incorporated by reference herein.

### TECHNICAL FIELD

This application generally relates to systems and methods that facilitate collaboration between entities based on similarity in respective audiences of the entities.

### BACKGROUND

Collaboration and cross-promotion between websites and other online entities is an excellent mechanism for increasing viewership and attracting new viewers, especially when the respective collaborating entities attract similar audiences. However, finding other entities to collaborate with is often difficult. For example, a content creator or business owner must first research other entities to learn which entity has an audience base the creator or business owner would be interested in reaching. After finding a suitable collaboration candidate, the creator or business owner must reach out to the collaboration candidate and persuade the candidate why collaboration and cross-promotion with one another would be beneficial to both entities. This second hurdle is often even more difficult than the first. Sometimes reaching out to other creators or businesses is like shouting into an empty void. Creators and businesses often get too many messages and business inquiries to respond to all of them. They also have no easy way to make decisions on whom to respond to first without investing at least some time into researching the respective inquiring entities.

### BRIEF DESCRIPTION OF THE DRAWINGS

Numerous aspects, embodiments, objects and advantages of the disclosed subject matter will be apparent upon consideration of the following detailed description, taken in conjunction with the accompanying drawings, in which like reference characters refer to like parts throughout, and in which:

FIG. 1 illustrates an example system for identifying and recommending channels for collaboration with one another based on similarity in audiences of the respective channels, in accordance with various aspects and embodiments described herein;

FIG. 2 provides a flow diagram of an example method for selecting a subset of channels provided by a media provider for recommending to another channel for collaboration/cross-promotion in accordance with aspects and embodiments described herein;

FIG. 3 presents a user interface that displays channels recommended for collaboration with a creator's channel in accordance with various aspects and embodiments described herein;

FIG. 4 illustrates another example system for identifying and recommending channels for collaboration with one another based on similarity in audiences of the respective channels, in accordance with various aspects and embodiments described herein;

FIG. 5 illustrates another example system for identifying and recommending channels for collaboration with one another based on similarity in audiences of the respective channels, in accordance with various aspects and embodiments described herein;

FIG. 6 illustrates another example system for identifying and recommending channels for collaboration with one another based on similarity in audiences of the respective channels, in accordance with various aspects and embodiments described herein;

FIG. 7 is a flow diagram of an example method for identifying and recommending channels for collaboration with one another based on similarity in audiences of the respective channels, in accordance with various aspects and embodiments described herein;

FIG. 8 is a flow diagram of another example method for identifying and recommending channels for collaboration with one another based on similarity in audiences of the respective channels, in accordance with various aspects and embodiments described herein;

FIG. 9 is a flow diagram of an example method for identifying and recommending channels for collaboration with one another based on similarity in audiences of the respective channels, in accordance with various aspects and embodiments described herein;

FIG. 10 is a schematic block diagram illustrating a suitable operating environment in accordance with various aspects and embodiments.

FIG. 11 is a schematic block diagram of a sample-computing environment in accordance with various aspects and embodiments.

### DETAILED DESCRIPTION

The innovation is described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and components are shown in block diagram form in order to facilitate describing the innovation.

By way of introduction, the subject matter described in this disclosure relates to systems and methods for automatically identifying and recommending Internet based entities (e.g., websites, webpages, user profiles, media channels, application service providers (ASPs), etc.) for collaboration and/or cross-promotion with one another based on similarity in audiences of the respective entities. Collaboration and cross-promotion between websites and other Internet based entities, is an excellent mechanism for increasing viewership and attracting new viewers, especially when the respective collaborating entities attract similar audiences. For example, a website that sells running apparel would likely benefit from collaboration and/or cross-promotion of its content with a website that markets road races based on the assumption that viewers of the respective websites are likely runners. According to this example, the running apparel website can cross-promote or advertise for the road racing website and vice versa.

However, finding other Internet based entities to collaborate with is often difficult because although audience type similarity may be assumed, it is difficult to determine the likelihood a particular audience member of one Internet based entity will view or access the content provided by the another Internet based entity. In addition, although two Internet based entities may have similar audiences, the entities may not be a suitable pair for collaboration/cross-promotion based on various additional factors, such inequality in audience size, inequality in social popularity, or a particular collaboration/cross-promotion purpose (e.g., to attract more viewers of a particular type or class).

Further, after an Internet based entity finds a suitable collaboration/cross-promotion through manual analysis and comparison between the Internet based entity and a candidate entity, the creator or owner of the Internet based entity must reach out to the candidate entity and persuade the candidate why collaboration and cross-promotion with one another would be beneficial to both entities. Due to the nature and sheer number of Internet based entities, this can be a long drawn out process that ultimately hinders collaboration and cross-promotion. For example, when Internet based entities provide a mechanism for the general public to contact the respective entities (e.g., posting an email address) they often get too many electronic messages and business inquiries to respond to all of them. They also have no easy way to make decisions on whom to respond to first without investing at least some time into researching the respective inquiring entities. In addition to the need for a tool that facilitates automatically identifying other Internet based entities for collaboration/cross-promotion, Internet based entities need a way to sort and filter incoming collaboration inquiries based on metrics that are relevant to the respective entities. This would allow the Internet based entities to prioritize incoming communication from other entities based on how useful a potential collaboration or cross-promotion would be.

The subject disclosure presents systems and methods for automatically identifying Internet based entities that would likely benefit from collaboration and/or cross-promotion with one another based on various metrics tailored to the type of the Internet based entities, specific characteristics of the Internet based entities, and the goals of the Internet based entities in association with collaboration/cross-promotion. In an exemplary embodiment, these metrics include similarity in audiences of the entities, and more particularly, a determined amount of shared audience members. In one or more embodiments, a system is configured to recommend entities identified as suitable collaboration/cross-promotion candidates to one another for entering into a collaboration and/or cross-promotion arrangement. In association with recommending these entities to one another, the system can generate and include information regarding why the respective entities are considered a suitable collaboration/cross-promotion match can also be provided to the respective entities. For example, information describing commonalities between their respective audiences can be provided.

In addition, the subject disclosure provides systems and methods that facilitate and police communication between entities recommended for collaboration/cross-promotion with one another. For example, when a first entity is recommended to a second entity for collaboration and/or cross-promotion, a messaging tool is enabled and associated with the recommendation that allows the second entity to send an electronic collaboration/cross-promotion message to the recommended entity. In an aspect, the collaboration message can be distinguished from other messages received by the recommended entity in such a manner as to indicate that it is a collaboration/cross-promotion message from a suitable matched/recommended entity. In another aspect, the messaging tool is only enabled for respective matches. According to this aspect, an entity cannot send a collaboration/cross-promotion message to another entity regarding collaboration/cross-promotion unless the other entity has been recommended to the entity as a collaboration/cross-promotion match.

The subject systems and methods do not merely recite the performance of some business practice known from the pre-Internet world along with the requirement to perform it using a computer on the Internet. Instead, the solution is necessarily rooted in computer technology in order to overcome a problem specifically arising in the realm of computer networks. In particular, the subject solution is specifically targeted to the goal of increasing viewership and usage of Internet based entities using collaboration and cross-promotion between the Internet based entities. More specifically, the subject disclosure addresses the various challenges associated with achieving this goal that are particular to the Internet, including finding suitable Internet based entities for collaboration/cross-promotion and facilitating communication between suitable collaboration/cross-promotion entities in a manner that efficiently and effectively achieves collaboration and/cross-promotion.

With the subject systems and methods, suitable Internet based entities are automatically identified for collaboration/cross-promotion based on metrics that are unique to consumption/usage of an Internet based entity (e.g., a website, a user profile, a channel). The Internet based entities do not have to perform manual research in order to find suitable collaboration/cross-promotion candidates. On the contrary, a computer network system is provided that automatically identifies and provides suitable collaboration/cross-promotion to one another. In addition, an Internet based entity does not need to sift through hundreds/thousands of messages to identify collaboration/cross-promotion inquires and further research the entities associated with the inquires to determine whether they are in fact a suitable candidate. On the contrary, communication tools are provided that uniquely distinguish and facilitate communication between only entities that have been determined suitable for collaboration/cross-promotion.

The subject mechanisms for facilitating collaboration between entities can be applied to a variety of entity types associated with an audience base. With respect to Internet based entities, the audience base can include users who view the entity, subscribe to the entity or purchase goods or services from the entity. For example, a suitable Internet based entity can include an online merchant whose audience include users that purchase goods or services from the online merchant via the merchant's website. In another example, a suitable Internet based entity can include an ASP whose audience includes those users who purchase or download an application serviced or provided by the ASP. For example, two applications that are purchased and downloaded by a similar group of users can be recommended to the respective ASPs for collaboration and cross-promotion. According to this example, cross-promotion can include advertising/promoting one of the applications in association with usage of the other. In yet another example, an Internet based entity that can employ the subject collaboration/cross-promotion tools can include a user's social networking profile hosted by a social networking system. The user's audience includes other users who are social networking friends of the user, who follow the user or who have otherwise associated themselves with the user. According to this example, different users could be recommended for collaboration/cross-promotion with one another based on similarity in friends/followers and number of friends/followers of the respective users.

Various aspects of the subject mechanisms for facilitating collaboration between entities are particularly exemplified herein with respect to facilitating collaboration between channels. As described herein, a channel can include data content available from a common source or data content having a common topic or theme. A channel can be associated with a curator who can perform management actions on the channel. Management actions may include, for example, adding media items to the channel, removing media items from the channel, defining subscription requirements for the channel, defining presentation attributes for channel content, defining access attributes for channel content, etc. The channel content can be digital content uploaded to the internet-based content platform by a channel curator and/or digital content selected by a channel curator from the content available on the Internet-based content platform. A channel curator can be a professional content provider (e.g., a professional content creator, a professional content distributor, a content rental service, a television (TV) service, etc.) or an amateur. Channel content can include professional content (e.g., movie clips, TV clips, music videos, educational videos) and/or amateur content (e.g., video blogging, short original videos, etc.). Users, other than the curator of the channel, can subscribe to one or more channels in which they are interested.

In one or more exemplary embodiments, channels recommended for collaboration and/or cross-promotion include media based channels hosted by an Internet based media sharing system. In particular, the media sharing system can provide an Internet based platform for users to upload and share their media content with other users. The media sharing system can employ channels as an avenue for respective users to associate and promote their user generated content. For example, the media sharing system can allow users to create or establish individual channels via which the users can upload and share their user generated media content. Each user's channel can include a collection of media items owned, created, endorsed or otherwise associated with the user (e.g., videos, songs, animations, images, collages, etc.). Users of the media sharing system can further view other users' channels and interact with the channels in various ways, including but not limited to, commenting on media content included in the channels, sharing media content included in the channels, and endorsing media content included in the channels. Users can also subscribe to a channel to associate themselves with the channel, receive updates regarding the channel (e.g., updates regarding new additions to the channel, updates regarding new comments on the channel, updates regarding popularity of the channel, etc.), interact with other subscribers to the channel, and various additional perks of being a subscriber to the channel.

According to these exemplary embodiments, a system is provided that identifies medial channels for collaboration and/or cross-promotion based in part on overlap between audience members of the media channels. For example, a first channel can be analyzed to identify other channels that have at least one common subscriber with the first channel. A filtering mechanism can also be applied to identify a subset of the other channels for recommending to the creator or owner (or entity otherwise afforded management rights to the channel) of the first channel for collaboration with the first channel. For example, parameters that can be employed to filter the other channels can include but are not limited to: number of common subscribers between the first channel and the respective other channels, total number of subscribers to the first channel, total numbers of respective subscribers to the other channels, number of common subscribers between the first channel and the other channels that are associated with a specific classification (e.g., top subscribers of the first channel, recent subscribers of the other channels, subscribers associated with different demographics, etc.), degree of engagement of the common subscribers with the respective other channels, and similarity of content between the first channel and the respective other channels.

Once a subset of channels recommended for collaboration with the first channel has been identified, the subset of channels can be presented to the creator (curator, owner, manager, etc.) of the first channel. For example, a user interface employed by the media sharing system that provides the creator of the first channel access to information and management functions for the first channel can include a collaboration section that lists the recommended channels. Each of the recommended channels can be associated with a link to a collaborative statistics page showing statics regarding similarities between the audiences of the recommended channel and the first channel. Each of the recommended channels can also be accompanied by a message button. Selection of the message button associated with a recommended channel can facilitate communication between the owner of the first channel and an owner of the selected channel. For example, selection of the message button can generate a collaboration message or post that is provided to a messaging inbox or user profile account for the owner of the recommended channel. In an aspect, the collaboration post or message can include a link to a collaborative statistics page showing statics regarding similarities between the audiences of the two channels.

In one or more embodiments, a system for facilitating cross-promotion between channels hosted by an Internet based media provider. The system includes a memory that stores computer executable components and a data store including information identifying the channels and respective subscribers to the channels. The system further includes a processor that executes various computer executable components stored in the memory, including an identification component configured to identify a set of the channels having at least one common subscriber to a first channel of the channels based on the information in the data store, and a ranking component configured to rank respective channels in the set based on number of common subscribers between the respective channels in the set and the first channel. The computer executable component further include a filter component configured to identify a subset of the set of channels based on the ranking of the respective channels, and a recommendation component configured to generate a recommendation with information identifying the subset of the channels as candidates for cross-promotion with the first channel, and provide the recommendation to an entity affiliated with management of the first channel.

In an aspect, the system further includes a messaging component configured to enable communication, via a dedicated messaging platform controlled by the Internet based media provider, between the entity affiliated with management of the first channel and the respective entities affiliated with management of the respective channels in the subset based on inclusion of the respective channels in the subset. In some aspects, the system can also include an automatic cross-promotion component configured to include first content on respective channels included in the subset that promotes the first channel in response to inclusion of the respective channels in the subset.

In other embodiments, a method is provided for facilitating cross-promotion between channels hosted by an Internet based media provider. The method includes storing information identifying the channels and respective subscribers to the channels in a data store, and using a processor to execute various computer executable instructions stored in a memory to perform acts, including identifying a set of the channels having at least one common subscriber to a first channel of the channels based on the information in the data store, and ranking respective channels in the set based on number of common subscribers between the respective channels in the set and the first channel. The processor is further configured to identify a subset of the set of channels based on the ranking of the respective channels, generate a recommendation comprising information identifying the subset of the channels as candidates for cross-promotion with the first channel, and providing the recommendation to an entity affiliated with management of the first channel.

In various additional embodiments, a tangible computer-readable storage medium is provided that includes computer-readable instructions that, in response to execution, cause an Internet based media system to perform various operations. The operations include but are not limited to, identifying a set of channels hosted by the Internet based media system having at least one common subscriber to another channel hosted by the Internet based media system, ranking respective channels in the set based number of common subscribers between the respective channels in the set and the other channel, identifying a subset of the set of channels based on the ranking of the respective channels, and generating a recommendation comprising information identifying the subset of the channels as candidates for cross-promotion with the other channel. These operations can further include providing the information identifying the subset of the channels to an entity affiliated with management of the other channel, and enabling communication, via a dedicated messaging platform controlled by the Internet based media system, between the entity affiliated with management of the other channel and the respective entities affiliated with management of the respective channels in the subset based on inclusion of the respective channels in the subset.

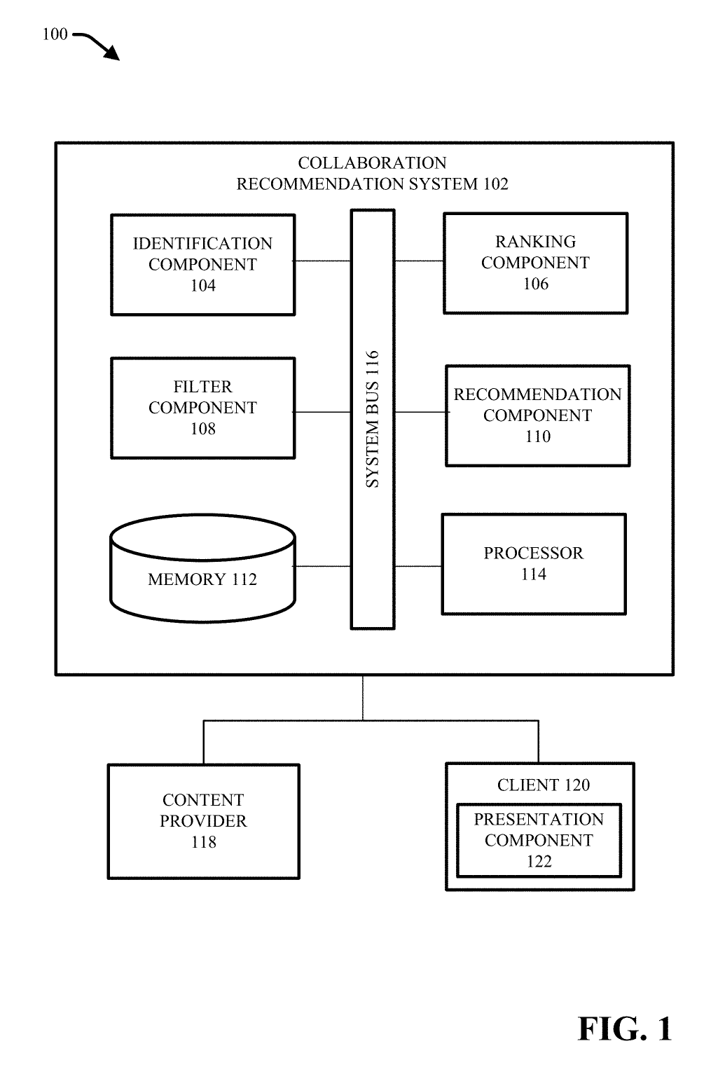

Referring now to the drawings, with reference initially to FIG. 1, presented is a diagram of an example system 100 that facilitates collaboration between entities based on similarity in respective audiences of the entities, in accordance with various aspects and embodiments described herein. Aspects of systems, apparatuses or processes explained in this disclosure can constitute machine-executable components embodied within machine(s), e.g., embodied in one or more computer readable mediums (or media) associated with one or more machines. Such components, when executed by the one or more machines, e.g., computer(s), computing device(s), virtual machine(s), etc. can cause the machine(s) to perform the operations described.

System 100 can include collaboration recommendation system 102, content provider 118, and client device 120. Collaboration recommendation system 102 can include identification component 104, ranking component 106, filter component 108, and recommendation component 110. Collaboration recommendation system 102 can also include memory 112 that stores computer executable components, and a processor 114 that executes the computer executable components stored in the memory (e.g., the identification component 104, the ranking component 106, the filter component 108, and the recommendation component 110). Collaboration recommendation system 102 further includes a system bus 116 that couples the various components including, but not limited to, identification component 104, ranking component 106, filter component 108, recommendation component 110, memory 112 and/or processor 114.

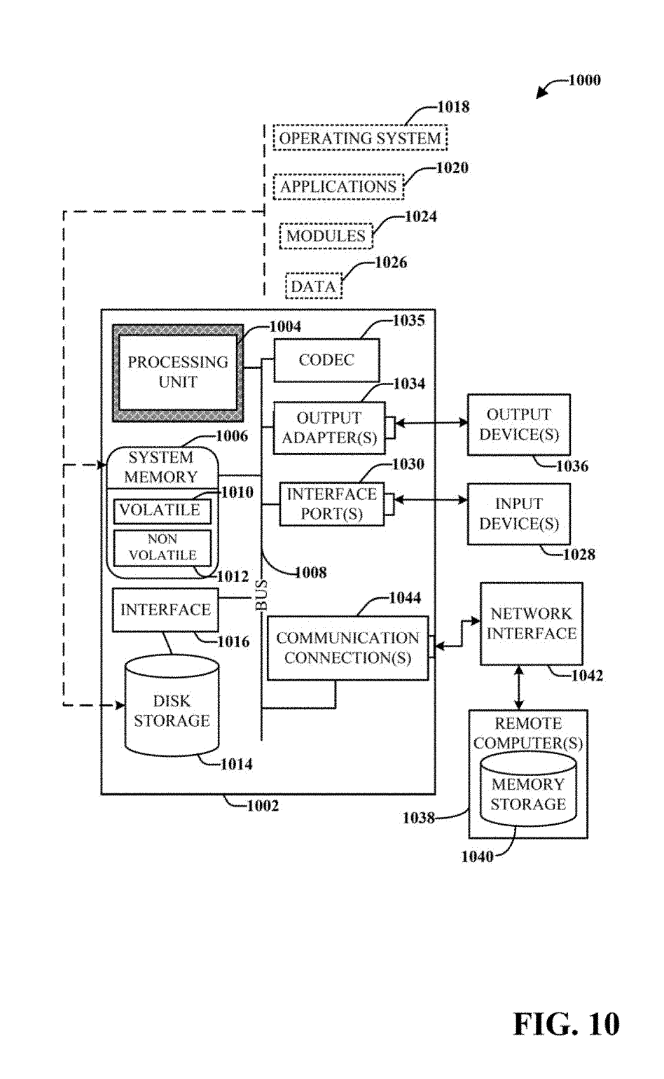

Collaboration recommendation system 102 is configured to identify Internet based entities having similar audiences and recommend these entities to one another for potential collaboration and cross-promotion. In an aspect, these entities can include websites, webpages, profiles, applications, playlists, or other types of data objects provided by a content provider 118 to a client devices (e.g., client device 120) via a network. In an exemplary embodiment, these entities include channels hosted by an Internet based media provider. Generally, collaboration recommendation system 102, content provider 118, and client device 120 include or employ one or more computing devices to provide for the various features and functionalities thereof, examples of which can be found with reference to FIG. 10.

The various components (e.g., collaboration recommendation system 102, content provider 118, and client device 120) of system 100 can be connected either directly or via one or more networks, (not shown). Such network(s) can include wired and wireless networks, including but not limited to, a cellular network, a wide area network (WAD, e.g., the Internet), a local area network (LAN), or a personal area network (PAN). For example, client device 120 can communicate with content provider 118 (and vice versa) using virtually any desired wired or wireless technology, including, for example, cellular, WAN, wireless fidelity (Wi-Fi), Wi-Max, WLAN, and etc. In an aspect, one or more components of system 100 are configured to interact via disparate networks. In another aspect, content provider 118 can include collaboration recommendation system 102 to facilitate identifying entities for collaboration and/or cross-promotion that are provided by the content provider 118 (e.g., channels provided by content provider where content provider is a media provider).

Content provider 118 can include an entity configured to provide content or content items to a user at a client device (e.g., client device 120) via a network (e.g., the Internet). For example, content provider 118 can include a website or application configured to present pictures, articles, blogs, videos, or other types of content items to client devices via a network. According to this example, the content provided by the website or application can be configured for downloading, streaming or merely viewing at a client device via the network. In another aspect, content provider 118 can include an information store that provides access to data included in the information store via a network.

As used herein, the term content item refers to any suitable data object that can be linked to and accessed or otherwise shared via a network and includes but is not limited to: documents, articles, messages, website, webpages, programs, applications, user profiles, and media items. In an aspect, a content item includes a data object that can be identified by a URL. The term media content or media item can include but is not limited to streamable and dynamic media (e.g., video, live video, video advertisements, music, music videos, sound files, animations, and etc.) and static media (e.g., pictures, thumbnails). The term media content or media item can also refer to a collection of media items such as a playlist including several videos or songs, or a channel including several videos or songs associated with a single media creator or curator.

In an exemplary embodiment, content provider 118 is an Internet based streaming media provider configured to provide streamed media to client devices over a network. For example, content provider 118 can include a media provider that has access to a voluminous quantity (and potentially an inexhaustible number) of shared media (e.g., video and/or audio) files. The media provider can further stream these media files to one or more users at respective client devices (e.g., client device 120) of the one or more users over a network. The media can be stored in memory associated with the media provider and/or at various servers employed by the media provider and accessed by client devices using a networked platform (e.g., a website platform, a cellular application) employed by the media provider.

For example, the media provider can provide and present media content to a user via a website that can be accessed by a client device using a browser. In another example, the media provider can provide and present media to a user via a mobile/cellular client application provided on a client device (e.g., where the client device is a smartphone or the like). Client device 120 can include presentation component 122 to generate a user interface (e.g., a graphical user interface or virtual interface) that displays media content provided by the media provider to a user of the client device and facilitates navigation/interaction with the media provider. In an aspect, presentation component 122 can include an application (e.g., a web browser) for retrieving, presenting and traversing information resources on the World Wide Web. For example, the media provider can provide and/or present media content to a client device 120 via a website that can be accessed using a browser of the client device 120. In another example, the media provider can provide and/or present media content to a client device 120 via a cellular application platform. According to this application, presentation component 122 can employ a client application version of the media provider that can access the cellular application platform of the media provider. In an aspect, the media content can be presented and/or played at client device 120 using a video player associated with the media provider and/or the client device 120.

Client device 120 can include any suitable computing device associated with a user and configured to interact with content provider and/or collaboration recommendation system 102. For example, client device 120 can include a desktop computer, a laptop computer, a television, an Internet enabled television, a mobile phone, a smartphone, a tablet personal computer (PC), or a personal digital assistant PDA. As used in this disclosure, the terms “content consumer,” “user,” or “creator” refers to a person, entity, system, or combination thereof that employs system 100 (or additional systems described in this disclosure) using a client device 120.

In one or more embodiments, collaboration recommendation system 102 can include identification component 104, ranking component 106, filter component 108, and recommendation component 110. Various aspects of collaboration recommendation system 102 are described herein in association with facilitating collaboration and/or cross-promotion between channels provided by content provider 118, where content provider 118 is a streaming media provider that includes channels. However, it should be appreciated that various aspects of collaboration recommendation system 102 described herein can be applied to facilitating collaboration and/or cross-promotion between other types of entities where the entities may attract similar audiences (e.g., websites, user profiles/accounts, specific goods/services or client applications available for downloading via an application store).

Identification component 104 is configured to identify different entities for collaboration and/or cross-promotion with one another based in part on similarities in audiences of the respective entities. In particular, where content provider 118 is a streaming media provider that includes channels, identification component 104 can identify channels that have similar audiences. Identification component 104 can employ various mechanisms to identify channels that have similar audiences. In various embodiments, identification component 104 is configured to identify channels having similar audiences based on an amount of shared or common subscribers between the respective channels. For example, as discussed infra, users of the media provider can access and view various channels provided by the media provider to consume the media content associated with the respective channels. Users can also subscribe to a channel to associate themselves with the channel, to receive news or updates regarding the channel (e.g., updates regarding new content added to the channel, updates regarding new comments on the channel, news regarding popularity of the channel, etc.), interact with other subscribers of the channel, and various additional perks of being a subscriber to the channel.

In accordance with an embodiment, to facilitate identifying other channels for cross-promotion/collaboration with a particular channel, identification component 104 can first analyze the particular channel to identify the subscribers to the particular channel. For example, the media provider can include (e.g., in memory 112) or have access to a data store that stores information regarding respective channels hosted by the media provider, including the subscribers to the respective channels and various information about the respective subscribers such as information regarding their interaction with the media provider (e.g., engagement, media watch/play history, media watch/play patterns) and other personal information about the respective subscribers (e.g., their preferences, demographics, classifications, etc.). Identification component 104 can further accesses subscriber information associated with a plurality of other channels provided by the media provider (e.g., content provider 118) to identify a set of the other channels that have at least one common subscriber with the particular channel.

In an aspect, identification component 104 can apply a minimum threshold for the number of common subscribers between the particular channel and another channel prior to inclusion in the set. For example, rather than identifying all channels with at least one common subscriber, identification component 104 can be configured to identify other channels with at least N common subscribers (e.g., where N is 10 or more, 20 or more, 50 or more, 100 or more, etc.) or at least M% common subscribers relative to total number of subscribers to the particular channel. According to this aspect, the values for N or M can also vary as based on the total number of subscribers to the particular channel being evaluated/compared to the plurality of other channels. For example, N or M can increase as the total number of subscribers to a particular channel being considered for collaboration/cross-promotion with other channel can increases. For instance, where the total number of subscribers to the particular channel is 100 or less, N can equal 10 or M can equal 5%, where the total number of subscribers to the particular channel is between 100-1000, N can equal 20 or M can equal 10%, etc.).

In another aspect, identification component 104 can be configured to identify a set of other channels having common subscribers with a particular channel that are associated with a particular attribute, characteristic or class. For example, the particular attribute, characteristic or class can relate to a particular user demographic (e.g., age, gender, location, language), a particular user preference or interest (e.g., a music type, a video genera, preferred actor, etc.), or a particular classification (e.g., a recent subscriber, a family member subscriber, a professional subscriber, an amateur, a top/fan subscriber, etc.). According to this aspect, rather than identifying a set of other channels that have at least one common general subscriber with the particular channel or at least M% common general subscribers with the particular channel, identification component 104 can be configured to identify a set of other channels that have at least one common subscriber, (or at least N or M% common subscribers), having a specific attribute, characteristic or class (e.g., being female, being a top fan, being between the ages of 10-18, being a fan of a particular actor, etc.). For example, identification component 104 can identify a subset of subscribers associated with the particular channel that have the specific attribute of interest (e.g., that are female, that are classified as top fans, that are between the ages of 10-18, that are a fan of a particular actor, etc.). Identification component 104 can then identify a set of other channels that have at least one, (or at least N or M%), common subscribers that are included in the subset of subscribers.

It should be appreciated that the attribute of interest used to select a subset of subscribers can vary depending on the implantation of system 100 and the particular cross-promotion/collaboration goals of the particular channel (e.g., to attract more female subscribers, to attract more professional subscribers, etc.). For example, some other suitable subscriber subsets of interest can include but are not limited to: subscribers classified as top fans, recent subscribers, subscribers that have shared at least R number of videos of the particular channel, subscribers who have watched a video of the particular channel within the past D number of days, or subscribers that have watched or liked a specific subset of videos included in the particular channel.

The term top fan is used herein with respect to a channel and other entities to refer to a user or subscriber that demonstrates a higher level of engagement, support or interaction with the particular channel or entity. In various embodiments, a channel subscriber can be classified as a top fan based in part on level of engagement with a channel. Engagement with a channel can be determined based on various factors, including but not limited to, number of media items from the channel viewed by the subscriber, frequency of viewing of media items from the channel, recency of viewing of media items from the channel, amount of sharing regarding the channel or media items from the channel, amount of commenting regarding the media items or the channel, or recency of subscription to the channel.

A subscriber can be considered a recent subscriber based on various metrics. In an aspect, a subscriber can be considered a recent subscriber if the subscriber subscribed to the channel within the past M number of days, weeks, months etc. In another aspect, identification component 104 can order the subscribers to a channel based on time of subscription and identify a predetermined number N of the most recent subscribers. For example, identification component 104 can identify the 50 most recent subscribers to a channel, the 100 most recent subscribers to a channel, the 100 most recent subscribers to a channel, etc.

After identification component 104 has identified a set of overlapping or common subscribers with a particular channel, ranking component 106 is configured to rank the respective channels included in the set based on a ranking factor that reflects a degree to which the respective channels are considered good/strong matches for collaboration and/or cross-promotion with the particular channel. Ranking component 106 can apply various algorithms and/or look up tables that relate various ranking factors associated with audience similarity, audience engagement, subscriber size, channel popularity, and/or content similarity, with scores representative of a degree to which a channel is a good or strong match for collaboration and/or cross-promotion with another channel.

In an aspect, ranking component 106 can rank respective channels included in a set identified by identification component 104 based on numbers of common subscribers between the respective channels and the first channel, wherein channels having a greater number or percentage of common subscribers can receive a higher ranking. For example, when ranking respective channels included in the set, ranking component 106 can score each channel by taking the number of subscription intersections (e.g., number of common subscribers between a channel in the set and the particular channel) and dividing it by the total number of subscribers in the particular channel. In another example, ranking component 106 can score each channel in the set by taking the number of subscription intersections and dividing it by the total number of subscribers in channel of the set. In yet another example, ranking component 106 can score each channel in the set by taking the number of subscription intersections and dividing it by the total number of subscribers in the particular channel or the channel of the set, whichever is larger. After each channel in the set has been scored, the channels can then be sorted in descending order based on their respective scores.

When ranking respective channels included in a set identified by identification component 104, ranking component 106 can also consider the number of total subscribers to the respective channels in the set such that channels having a greater number of total subscribers can receive a higher ranking. For example, a channel included in the set having 10,000 total subscribers and 10% common subscribers can receive a higher ranking than a channel having 1000 total subscribers and 15% common subscribers.

Ranking component 106 can also rank respective channels included in a set based on level of engagement of the common subscribing users with the respective channels. For example, although a user may be subscribed to both the particular channel being evaluated and another channel, the user may have not watched a single video of the other channel or may have not viewed the other channel in over a month. As a result, entering a collaboration and/or cross-promotion agreement in attempt to reach the user at the other channel will likely be unproductive. Accordingly, ranking component 106 can apply a rule that associates a higher ranking with channels included in the set having a greater number of highly engaged common subscribers higher than channels that have a lower number of highly engaged common subscribers. For example, where two channels have similar numbers or percentages of common subscribers, the channel with the greater number of engaged common subscribers can be ranked higher than the channel with the lower number of engaged common subscribers.

As previously noted, engagement with a channel can be determined based on various factors, including but not limited to, number of media items from the channel viewed by the subscriber, frequency of viewing of media items from the channel, recency of viewing of media items from the channel, amount of sharing regarding the channel or media items from the channel, amount of commenting regarding the media items or the channel, or recency of subscription to the channel. In one example, when factoring user engagement into ranking channels respective channels of the set, ranking component 106 can evaluate each channel in the set to determine a total number of videos of the channel watched by the common subscribers, or a total watch time at the channel by the common subscribers. According to this example, a first channel in the set having only 5% common subscribers with the particular channel but a total watch time at the first channel by the common subscribers of 100 hours can receive a higher ranking than a second channel in the set having 10% common subscribers but a total watch time at the second channel of 50 hours.

In another aspect, ranking component 106 can consider popularity of the respective channels included in the set when determining their respective rankings, where popularity of a channel in the set is based on all subscribers and/or viewers of the channel (not just the common subscribers). Channel popularity can be based on various factors, including but not limited to, number of views of the channel, number of subscribers to the channel, level of user engagement with the channel (e.g., viewing, commenting, sharing, liking, re-watching, favoriting, etc.), social media attention received by the channel, etc. According to this aspect, channels included in the set that are considered more popular than other channels can receive a higher ranking than the other channels. For example, a first channel in the set having 50 common subscribers and a popularity score of 9/10 can receive a higher ranking then a second channel in the set having 100 common subscribers yet a popularity ranking of 3/10. In some embodiment aspects, ranking component 106 can evaluate channel popularity with respect to a particular audience subset (e.g., a subset based on a specific user characteristic employed to restrict the channels included in the set by identification component 104). For example, where identification component 104 identifies a set of channels having a common subset of subscribers, such as a common subset of female subscribers under the age of 30, ranking component 106 can rank the channels in the set based on popularity of the respective channels with female users under the age of 30. It is noted again that the popularity of channel in the set can be based on common and non-common subscribing users as well as non-subscribing users of the channel (e.g., general viewers).

After a set of channels has been identified by identification component 106 and ranked by ranking component 106, filter component 108 is configured to select a subset of the respective channels included in the set for recommending to the creator (owner, curator, manager, etc.) of the particular channel being evaluated based on the ranking and/or the factors employed to determine the ranking. For example, filter component 108 can apply a threshold whereby channels having a ranking of Y or above are selected for recommending to the creator of the particular channel. In another example, ranking component 106 can identify the top M amount of channels having the highest ranking for recommending to the first user (e.g., the top 20 channels with the highest rankings, the top 10% of the channels having the highest ranking, etc.). It should be appreciated that a ranking or score associated with the respective channels included in set the can reflect the various ranking factors discussed above, including but not limited to: number common subscribers between the respective channels in the set and the particular channel, number of total subscribers to the respective channels in the set, engagement of the common subscribers with the respective channels in the set, popularity of the respective channels in the set, and similarity of content between the first channel and the respective channels in the set.

In an aspect, in addition to or in the alternative to employing ranking to identify a subset of the channels for recommending to the creator of the particular channel, filter component 108 can filter the set of channels based on the specific factors employed to determine the ranking. For example, filter component 108 can identify a subset of the set of channels identified by identification component 104 based on number of common subscribers between the respective channels in the subset exceeding a threshold value. For example, filter component 108 can identify a subset of the set of channels wherein the total number intersecting subscribers between the particular channel and recommended channel is at least X% of the larger channel (e.g., 10%, 20%, 50%, etc.). In another example, filter component 108 can identify the subset of channels for recommending based on based on total watch time of common subscribers at a recommended channel exceeding a threshold value. In another example, filter component 108 can identify the subset of channels for recommending based on based on popularity of the recommended channel exceeding a threshold value.

In various embodiments, filter component 108 can further ensure that channels of similar sized are recommended to one another for collaboration/cross-promotion. For example, filter component 108 can ensure that a popular channel having over 10,000 subscribers is not paired with a smaller channel having merely 1000 subscribers. According to this aspect, filter component 108 can filter a set of channels based on a ratio of the number of subscribers to the particular channel being evaluated and number of subscribers to respective channels in the subset exceeding a threshold value. For example, filter component 108 can filter the set to identify a subset of the channels in the set having between 20% and 200% of the number of subscribers in the particular channel.

In another embodiment, filter component 108 can filter a set of channels identified by identification component 104 based on a subset of subscribers having a particular characteristic or classification when the identification component 104 does not employ this metric to generate the initial set of channels having at least one (or at least N or M%) common subscriber with the particular channel being evaluated. For example, identification component 104 can identify a set of channels having at least one common subscriber with a first channel and filter component 108 can further filter this set to identify a subset of the set of channels that have at least M common subscribers who are classified as top fans.

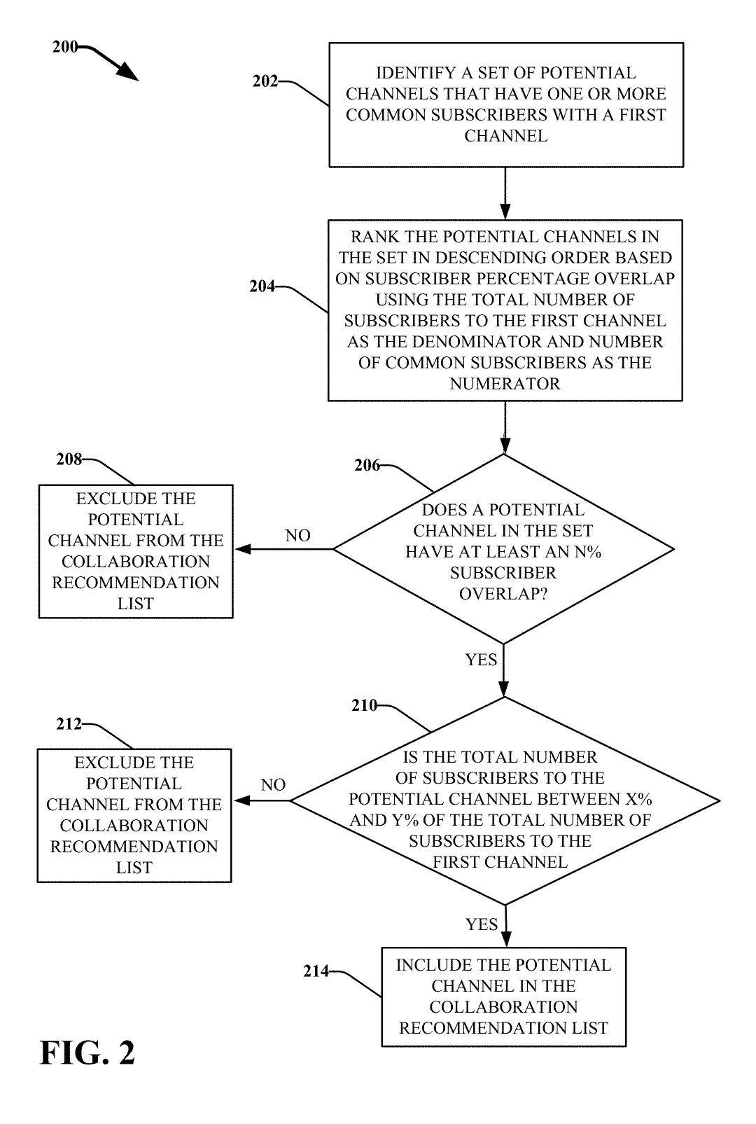

FIG. 2 provides a flow diagram of an example method 200 for selecting a subset of channels for recommending to another channel for collaboration/cross-promotion in accordance with aspects and embodiments described herein. Repetitive description of like elements employed in respective systems, devices, and processes described herein is omitted for sake of brevity.

At 202, a set of potential channels is identified that have one or more common subscribers with a first channel. In an aspect, the set of potential channels can be initially identified based on a more restrictive initial filter criteria. For example, rather than identifying all channels with one or more common subscribers to the first channel, all channels having at least 10 common subscribers or 10% common subscribers to the first channel can be identified. In another example, rather than identifying all channels with one or more common subscribers to the first channel, all channels having one or more or the first channels “top subscribers” can be identified.

At 204, the potential channels in the set are ranked in descending order based on subscriber percentage overlap using the total number of subscribers to the first channel as the denominator and the number of common subscribers as the numerator. In particular, each of the potential channels are assigned a ranking based on the number of common subscribers between the potential channel and the first channel divided by total number of subscribers to the first channel (e.g., [number of common subscribers between potential channel and first channel]/[total number of subscribers to the first channel]).

Each potential channel in the set is then evaluated using the criteria/thresholds defined in blocks 206 and 210 to determine whether to include it in a recommendation list for recommending to the creator/owner of the first channel for collaboration/cross-promotion. In particular, at 206, it is determined whether a potential channel in the set has at least an N% subscriber overlap, where N is a predetermined number. The value of N can vary based on the implementation of method 200. In an aspect, N equals 10. In another aspect, N equals 15. In another aspect, N equals 30. In yet another aspect, N equals 50. If the potential channel does not have at least the N% subscriber overlap, then at 208, the potential channel is excluded from the collaboration recommendation list. If it is determined that the potential channel does have the at least N% subscriber overlap, then process 200 continues to the next threshold criteria at 210.

In particular, at 210, it is determined whether the total number of subscribers to the potential channel is between X% and Y% of the total number of subscribers to the first channel. This threshold criteria facilitates ensuring that channels of like size (wherein size is a function of number of subscribers) are recommended to one another for collaboration/cross-promotion. The values of X and Y can vary depending on the implementation of method 200. In an aspect, X can equal 20 and Y can equal 200. In another aspect, X can equal 40 and Y can equal 150. If it is determined that the total number of subscribers to the potential channel is between X% and Y% of the total number of subscribers to the first channel, then at 214, the potential channel is included in the collaboration recommendation list. However, if it is determined that the total number of subscribers to the potential channel is not between X% and Y% of the total number of subscribers to the first channel, then at 212, the potential channel is excluded in the collaboration recommendation list.

With reference back to FIG. 1, recommendation component 110 is configured to recommend a subset of Internet based entities identified for collaboration/cross-promotion with a particular Internet based entity. With regards to channels hosted by a streaming media provider, recommendation component 110 is configured to recommend channels included in a subset based on audience similarity with a particular channel (e.g., identified by identification component 104 and established by ranking component 106 and filter component 108) to an entity affiliated with management of the particular channel (e.g., the creator channel) for potential collaboration and/or cross-promotion. In an aspect, recommendation component 110 is configured to generate a recommendation including information identifying the subset of the channels as candidates for cross-promotion with the particular channel, and provide the recommendation to the entity affiliated with management of the particular channel. The recommendation can also include information (e.g., a statistical summary) identifying why the each of the respective channels in the subset were determined to be good candidates for collaboration/cross-promotion with the particular channel.

In an embodiment, the recommendation component 110 is configured to render the recommendation to the entity affiliated with management of the particular channel via a graphical user interface associated with access of the first channel via an Internet based platform employed by the Internet based media provider. For example, a user interface provided by the media provider that includes or is associated with a user's channel/profile page can include a collaboration recommendation section. The recommendation component 110 can regularly update and include channels presented in the recommendation section based on those selected by filter component 108.

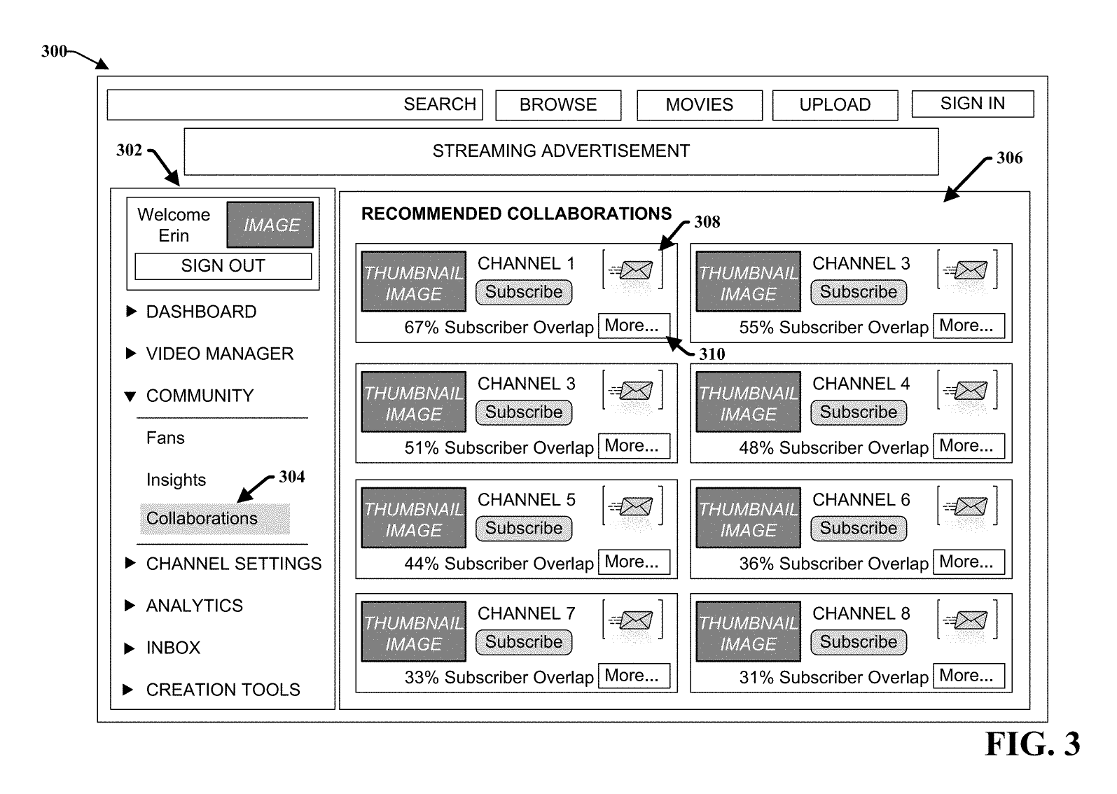

For example, FIG. 3 provides an example user interface 300 that provides a channel creator access to information and management operations pertaining to the creator's channel in accordance with aspects and embodiments disclosed herein. In example user interface 300, the creator's username is Erin. Erin has signed into her channel account at a website (or other type of Network accessible platform) established by a media provider that hosts Erin's channel. Interface 300 can include several menu options that relate to various information and management functions regarding Erin's channel. For example, menu 302 includes several options or features to access, including a dashboard feature, a video manager feature, a community feature, a channel settings feature, an analytics feature, an inbox feature, and creation tools feature. Erin has selected the community option which has several menu subcategories including fans, insights and collaborations.

Erin has further selected the collaborations subcategory 304. Selection of the collaborations subcategory 304 can result in the display of a recommended collaborations section 306. The recommended collaborations section 306 can present (e.g., in list form, in a thumbnail form, etc.) the various channels recommended to Erin for collaboration with her channel. For example, recommended collaborations section 306 lists eight channels (e.g., channels 1-8). In an aspect, each of the recommended channels can be associated with information representing the channel, such as a thumbnail image representative of the channel and a name for the channel. The channels can also be presented with information identify a percentage overlap between the subscribers of the channel and the subscribers to Erin's channel. Each of the recommended channels can be associated with a link 310 to more information about why the channel is considered a good candidate for collaboration and/or cross-promotion. For example, selection of link 310 can take Erin to a collaborative statistics page showing statics regarding similarities between the audience of the recommended channel and the audience of Erin's channel.

Each of the recommended channels can also be accompanied by a message button 308. Selection of the message button associated with a recommended channel can facilitate communication between Erin and the creator of the selected channel. For example, selection of the message button 308 can generate a collaboration message or post that is provided to a messaging inbox or user profile account for the creator of the recommended channel. In an aspect, the collaboration post or message can include a link to a collaborative statistics page showing statics regarding similarities between the audiences of the two channels.

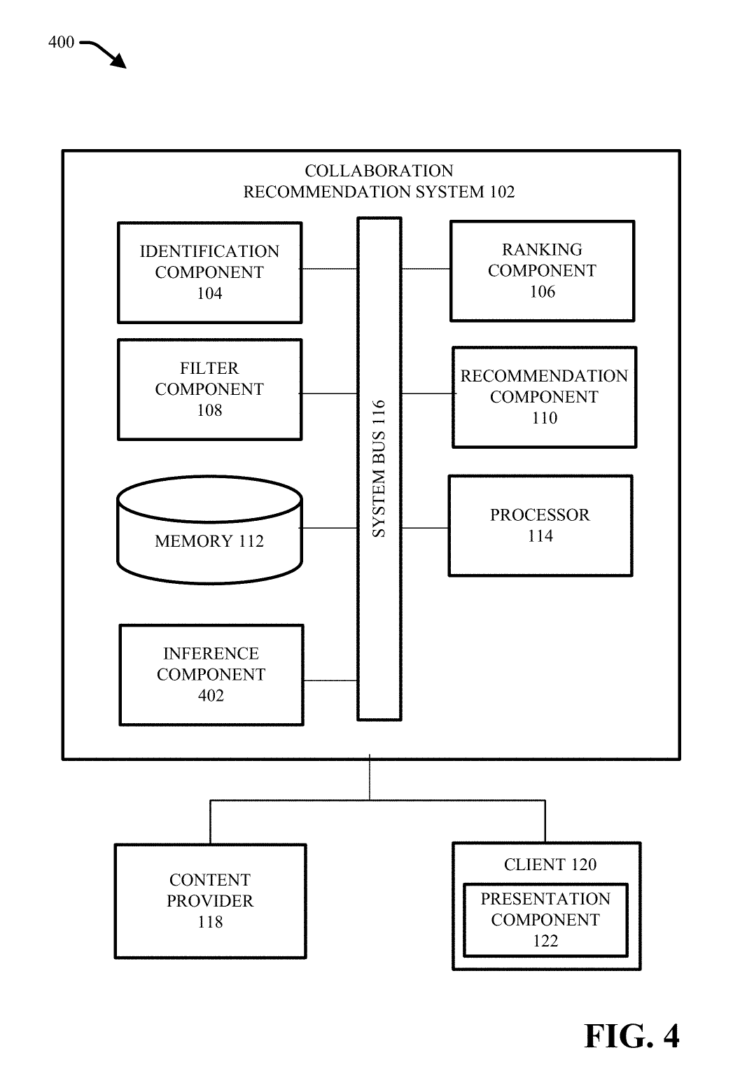

FIG. 4 presents another example system 400 that facilitates collaboration between entities based on similarity in respective audiences of the entities in accordance with various aspects and embodiments described herein. System 400 can include same or similar functionalities as system 100 with the addition of inference component 402 to collaboration recommendation system 102. Repetitive description of like elements employed in respective embodiments of systems and components described herein are omitted for sake of brevity.

Inference component 402 is configured to provide for or aid in various inferences or determinations associated with aspects of collaboration recommendation system 102. For example inference component 402 can facilitate identification component 104 and filter component 108 with identifying a set or subset, respectively, of entities (e.g., channels) for potential collaboration and/or cross-promotion with another entity (e.g., channel). In another example, inference component 402 can facilitate ranking component 106 with determining a ranking for a channel that reflects a degree to which the respective channels are considered a good match for collaboration and/or cross-promotion with the first channel. According to this example, inference component 402 can infer a ranking for a channel based on audience similarity, audience engagement, subscriber size, channel popularity, and/or content similarity. Inference component 402 can further infer a ranking based on historical data regarding previous collaborations between two channels and previous channel collaboration recommendations that were provided to the respective channels and disregarded by the respective channels. Inference component 402 can have access to the various components of collaboration recommendation system 102, content provider and/or client device 120 as well as other external systems and sources accessible via a network.

In order to provide for or aid in the numerous inferences described herein, inference component 402 can examine the entirety or a subset of the data to which it is granted access and can provide for reasoning about or infer states of the system, environment, etc. from a set of observations as captured via events and/or data. An inference can be employed to identify a specific context or action, or can generate a probability distribution over states, for example. The inference can be probabilistic—that is, the computation of a probability distribution over states of interest based on a consideration of data and events. An inference can also refer to techniques employed for composing higher-level events from a set of events and/or data.

Such an inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x4, x4, xn), to a confidence that the input belongs to a class, such as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

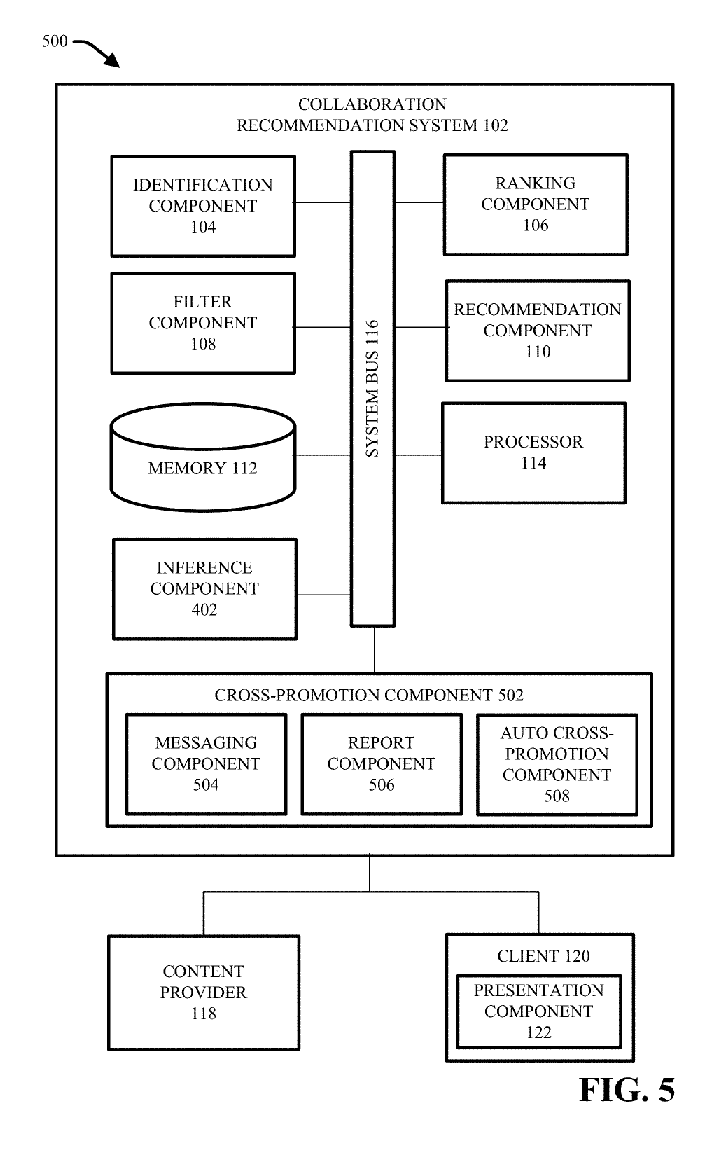

FIG. 5 presents another example system 500 that facilitates collaboration between entities based on similarity in respective audiences of the entities, in accordance with various aspects and embodiments described herein. System 500 can include same or similar functionalities as system 400 with the addition of cross-promotion component 502 to collaboration recommendation system 102. Repetitive description of like elements employed in respective embodiments of systems and components described herein are omitted for sake of brevity.

Cross-promotion component 502 is configured to facilitate connection and communication between entities recommended for collaboration by recommendation component 110. Cross-promotion component 502 can include messaging component 504, report component 506, and automatic cross-promotion component 508. Messaging component 504 is configured to facilitate communication Internet based entities recommended for collaboration/cross-promotion with one another via the mechanisms disclosed herein. In particular, messaging component 504 is configured to facilitate communication between the entity affiliated with management of the particular channel to which a subset of other channels has been recommended to for collaboration/cross-promotion, and respective entities affiliated with management of the other channels based on inclusion of the other channels in the subset. For example, messaging component 504 is configured to enable a creator of a first channel to contact or otherwise communicate with a creator of another channel recommended for collaboration/cross-promotion with the first channel in a secure manner.

In an embodiment, when a channel is recommended to a first channel creator for collaboration and/or cross-promotion with the first channel, messaging component 504 can associate a messaging tool with the recommendation that allows the creator of first channel creator to send a collaboration message to the recommended entity regarding collaboration and/or cross-promotion. In an aspect the message can be in the form of an email or short messaging service message (SMS). In another aspect, the message can be in the form of a post to a messaging board that is accessible to both channel creators. According to this aspect, the respective channel creators can receive a notification when a collaboration message has been posted to the messaging board.

In an aspect, messaging component 504 can distinguish the collaboration message from other messages so that the receiving entity can easily prioritize the message over other received inquires. For example, the message can be marked or color coded to indicate that the message is a collaboration/cross-promotion message from a matched entity. However, in an exemplary embodiment, messaging component 504 is configured to restrict collaboration/cross-promotion messaging between channel creators based on whether the two creator's channels have been recommended for collaboration/cross-promotion and/or a ranking associated with the strength of the collaboration/cross-promotion match. For example, messaging component 504 can only enable the messaging tool for respective matches or respective matches with a subscriber overlap over X%. (e.g., 75%). According to this aspect, a channel creator cannot send a collaboration message to another channel creator (and vice versa) regarding collaboration and/or cross-promotion unless the other entity has been recommended to the entity as a collaboration/cross-promotion match.

In an embodiment, in order to restrict messaging between channel owner/creators in association with a request for collaboration/cross-promotion, the media provider hosting the channels can include or employ a private or dedicated messaging platform associated with collaboration/cross-promotion. This private or dedicated messaging platform can be enabled and/or made accessible to respective Internet based entities only after the respective Internet based entities have been recommended to one another for collaboration/cross-promotion. According to this embodiment, the messaging component 504 is configured to enable communication, via the dedicated messaging platform controlled by the Internet based media provider, between an entity affiliated with management of a first channel and the respective entities affiliated with management of other channels based on and/or in response to inclusion of the respective channels in the subset. Likewise, the messaging component 504 is configured to disable communication, via the dedicated messaging platform controlled by the Internet based media provider, between an entity affiliated with management of a first channel and the an entity affiliated with management of another channel based on exclusion of the channel from a recommended subset of channels provided by the media provider.

Report component 506 is configured to generate data identifying why two channels are considered a suitable collaboration/cross-promotion match. This information can further be provided to the respective channel creators to facilitate evaluating whether to enter into a collaboration and/or cross-promotion agreement. For example, report component 506 can generate a report or collaborative statistics page with information describing commonalities between respective audiences of the two channels. For instance, a collaborative statistics page can include information comparing first creator's channel to another channel with respect to number of common subscribers, number of total subscribers, number of common subscribers belonging to respective subsets of subscriber types, and/or engagement of common subscribers with the respective channels (e.g., with respect to videos watched, liking, sharing commenting etc.). The report can also include a description of the respective channels. In an aspect, a link to the report or collaborative statistic page can be provided to the respective channel creators in association with a recommendation and/or collaboration message.

In various embodiments, automatic cross-promotion component 508 is configured to facilitate automatic cross-promotion between entities identified as suitable candidates for collaboration/cross-promotion. For example, cross-promotion between media channels can include advertising/promoting a first channel hosted by the media provider at a second channel hosted by the media provider. For instance, in association with access of the second channel by various users of the Internet based media provider, content such as still images, text, icons, video advertisements, trailers, links, and other data representing and/or associated with the first channel can be presented or displayed at the second channel. Accordingly, users of the second channel will be informed about content at the first channel and/or prompted to access the first channel.

In an embodiment, in response to inclusion of a channel in a subset of channels recommended for collaboration/cross-promotion with a first channel (e.g., using the mechanisms discussed herein afforded by identification component 104, ranking component 106 and filter component 108), automatic cross-promotion component 508 is configured to automatically include/integrate content associated with the first channel on at least one of the channels included in the subset. For example, automatic cross-promotion component 508 can include an advertisement for the first channel on all of the channels included in the subset. In an aspect, when a subset includes two or more channels automatic-cross promotion component 508 can apply a filter criteria that selection of one or more channels of the subset of channels at which to automatically include/integrate content associated with the first channel. The filter criteria can be based on the various metrics discussed in association with filter component 108. For example, automatic cross-promotion component 508 can be configured to select the channel in the subset having the highest ranking or the top three channels in the subset having the most common top-subscribers.

In another embodiment, in response to inclusion of a channel in a subset of channels recommended for collaboration/cross-promotion with a first channel, automatic cross-promotion component 508 is configured to automatically include/integrate content associated with the at least one of the channels of the subset at the first channel. Once again, when the subset includes two or more channels, automatic cross-promotion component 508 can be configured to select one or more of the channels of the subset for which to included content thereof at the first channel using the filter criteria discussed herein. In yet another embodiment, in response to inclusion of a channel in a subset of channels recommended for collaboration/cross-promotion with a first channel, automatic cross-promotion component 508 is configured to automatically include/integrate content of the first channel on at least one of the channels included in the subset, and include/integrate content associated with at least one of the channels of the subset at the first channel.

In various embodiments, automatic cross-promotion component 508 can be restricted to performing automatic cross-promotion between channels identified as suitable candidates for collaboration/cross-promotion with one another based on prior authorization provided by the respective channel owners/creators (or entity otherwise affiliated with management of a channel). According to this embodiment, an owner of a first channel can provide prior authorization regarding whether and under what conditions (e.g., the statistical thresholds used to determine that a channel is a candidate for automatic cross-promotion, and/or various other user defined conditions) content associated with or representative of the first channel can be automatically cross-promoted on another channel. Likewise, a channel owner can provide prior authorization regarding whether and under what conditions content associated with or representative of the another channel can be automatically cross-promoted on the first channel.

Still in yet another embodiment, after two channels have been identified as suitable candidates for collaboration/cross-promotion (e.g., a first channel and a channel included in a subset of recommended channels), automatic cross-promotion can be configured to notify the owners of the respective channels. The owners of the respective channels can further respond to the notification by providing authorization to cross-promote (e.g., content from one channel will be advertised on the other channel, and vice versa) or by providing an indication of rejection of cross-promotion. Based on the responses received from the respective channel owners, the automatic cross-promotion component 508 can be configured to proceed with automatic cross-promotion or abort automatic cross-promotion.

For example, the automatic cross-promotion component 508 can be configured to include/integrate content advertising a first channel on a second channel only in response to acceptance of the arrangement by the first channel owner and the second channel owner. In another example, the automatic cross-promotion component 508 can be configured to include/integrate content advertising a first channel on a second channel only in response to reception of authorization by the first channel owner to allow content from the first channel to be promoted on the second channel and to allow content from the second channel be promoted on the first channel. According to this example, prior to proceeding with the cross-promotion, the owner of the second channel would also have to authorize the cross-promotion arrangement.

The particular content associated with a channel that is automatically included/integrated on/at another channel by cross-promotion component 508 can be predefined. For example, the content can include but is not limited to: a video trailer for a channel, an icon representative of a channel, an image representative of a channel, a video or image advertisement for a channel, or a link to a first channel. In addition, the manner in which the content is included/integrated on/at a channel can be predefined (e.g., as an in-stream advertisement, as an overlay advertisement, as a banner advertisement, as a complimentary advertisement, etc.).

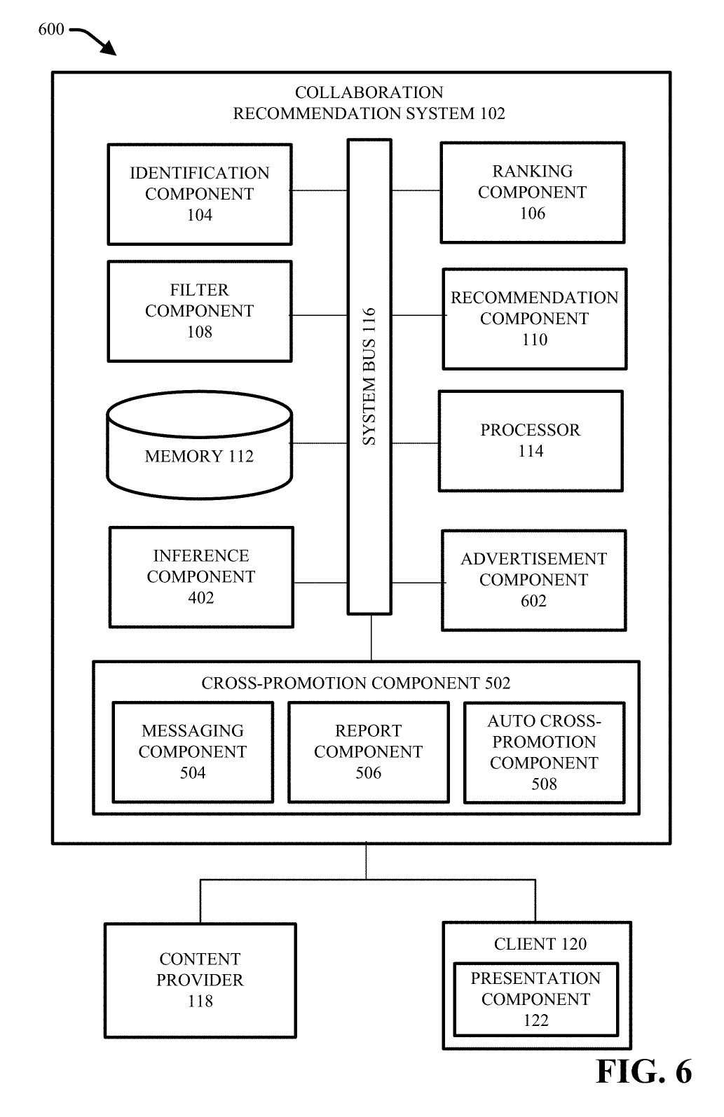

FIG. 6 presents another example system 600 that facilitates collaboration between entities based on similarity in respective audiences of the entities, in accordance with various aspects and embodiments described herein. System 600 can include same or similar functionalities as system 500 with the addition of advertising component 602 to collaboration recommendation system 102. Repetitive description of like elements employed in respective embodiments of systems and components described herein are omitted for sake of brevity.

Advertising component 602 is configured to receive information regarding channels recommended for collaboration and/or cross-promotion and identify advertisements for associating with a channel and/or a video provided by the channel based on the information. For example, advertising component 602 can analyze information identifying why two channels are considered good matches for collaboration and/or cross-promotion. According to this example, advertising component 602 can learn that two channels have a similar audience or a similar audience of a particular subscriber subset. The advertising component 602 can also discover channels that have common audience members or subscribers that are highly engaged with the respective channels.

In addition advertising component can analyze information related to type of content provided by two channels recommended for collaboration and/or cross-promotion. For example, advertising component 602 can identify channels that provide similar content or related and complimentary content. According to this example, advertising component 602 can learn that a first channel recommended for collaboration with a second channel includes videos related to interior home improvement and a second channel includes videos related to exterior home improvement.

Based on the various analysis performed by advertising component 602, advertising component can select an advertisement for associating with channels recommended for collaboration and/or cross-promotion. In furtherance to the above example, advertising component 602 can select an advertisement related to exterior home improvement for association with the first channel and another advertisement related to interior home improvement for association with the second channel.

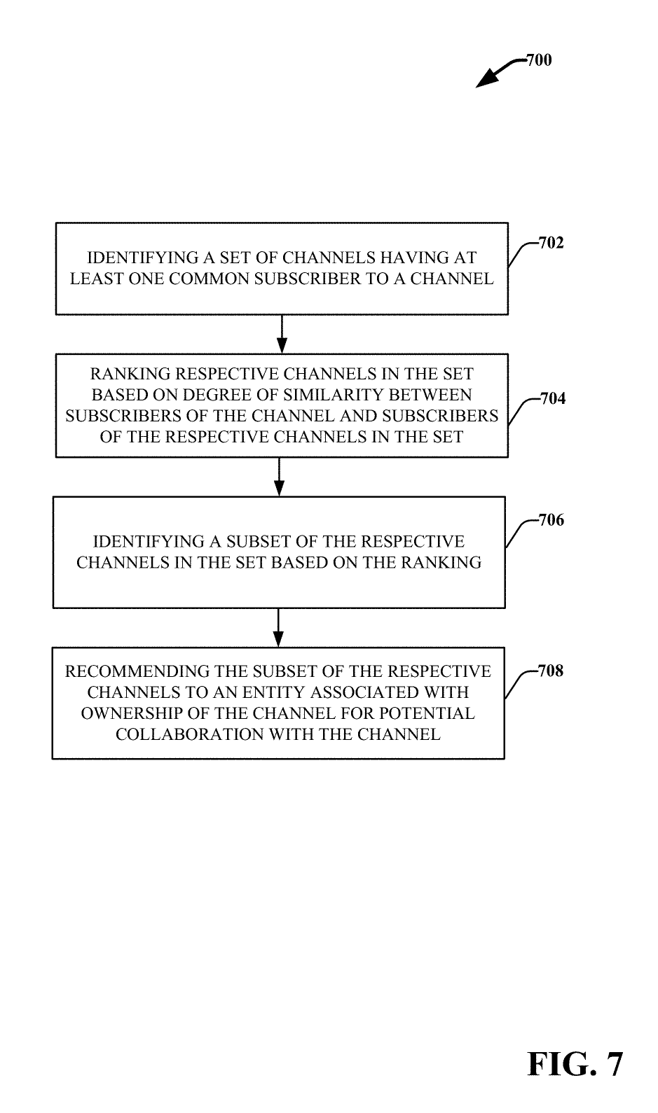

In view of the example systems and/or devices described herein, example methods that can be implemented in accordance with the disclosed subject matter can be further appreciated with reference to flowcharts in FIGS. 7-9. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 7 illustrates a flow chart of an example method 700 that facilitates collaboration between entities based on similarity in respective audiences of the entities, in accordance with various aspects and embodiments described herein. At 702 a set of channels having at least one common subscriber to a channel are identified (e.g., via identification component 104). At 704, respective channels in the set are ranked based on degree of similarity between subscribers of the channel and subscribers of the respective channels in the set (e.g., via ranking component 106). For example, the respective channels can be associated with a ranking or score that reflect a degree to which the respective channels are considered good matches for collaboration and/or cross-promotion with the channel. The ranking or score can be based on various factors including but not limited to: audience similarity (between the channel and another channel included in the set), engagement of common subscribers between the channel and another channel in the set with respect to the other channel in the set, subscriber size, channel popularity, and/or content similarity.

At 706 a subset of the respective channels in the set are identified based on the ranking (e.g., by filter component 108). For example, a subset of channels can be selected that have a ranking over minimum ranking or the top N highest ranked channels can be identified (e.g., the top 10 best matches). Then at 708 the subset of the respective channels are recommended to an entity associated with ownership of the channel for potential collaboration with the channel (e.g., by recommendation component 110). For example, a first channel can collaborate with a second channel having a similar audience by having the second channel promote the first channel using advertisements for the first channel (e.g., a link to the first channel, a video overly linking to a video provided by the first channel, etc.) in association with playing videos provided by the second channel, and vice versa.

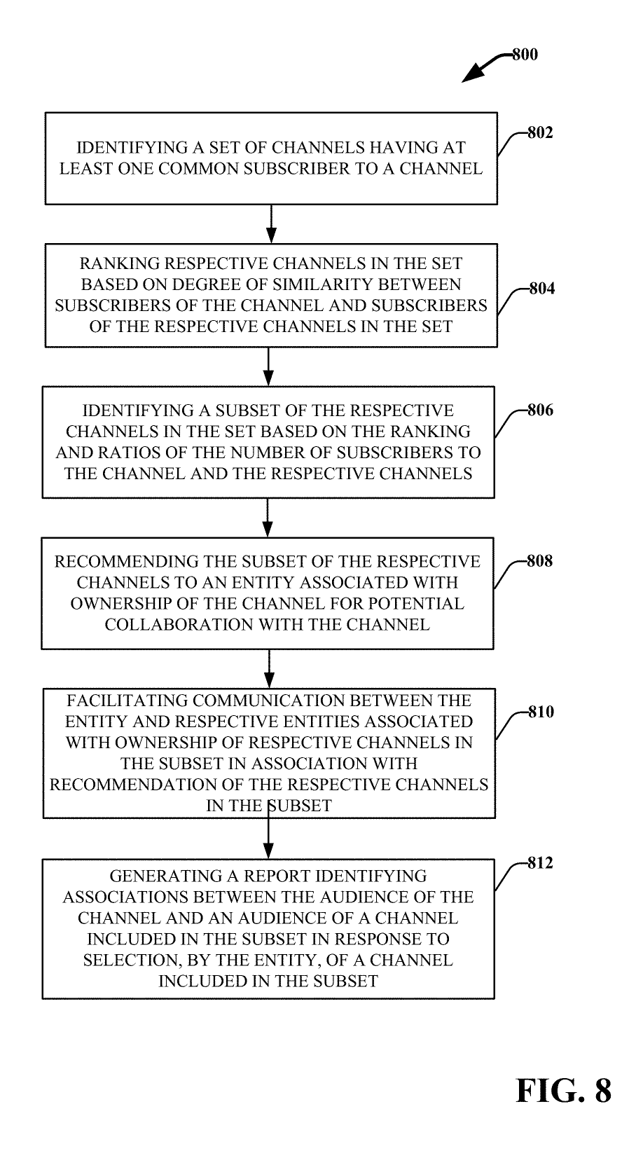

FIG. 8 illustrates a flow chart of another example method 800 that facilitates collaboration between entities based on similarity in respective audiences of the entities, in accordance with various aspects and embodiments described herein. At 802 a set of channels having at least one common subscriber to a channel are identified (e.g., via identification component 104). In an aspect, rather than identifying all common subscribers, a particular subset of common subscribers can be identified. For example, a set of other channels can be identified that include at least one subscriber included in a subset of subscribers to the channel that are classified as top fans, recent subscribers, or associated with a particular characteristic (e.g., demographic, user preference, etc.). At 804, respective channels in the set are ranked based on degree of similarity between subscribers of the channel and subscribers of the respective channels in the set (e.g., via ranking component 106).

At 806 a subset of the respective channels in the set are identified based on the ranking and ratios of the number of subscriber to the channel and the respective channels (e.g., by filter component 108). For example, a subset of channels can be selected that have a ranking over minimum ranking and that are a similar size (e.g., based on number of subscribers) to the channel. At 808 the subset of the respective channels are recommended to an entity associated with ownership of the channel for potential collaboration with the channel (e.g., by recommendation component 110). At 810, communication between the entity and respective entities associated with ownership of respective channels in the subset is facilitated in association with recommendation of the respective channels in the subset (e.g., via cross-promotion component 502). At 812, a report is generated identifying associations between the audience of the channel and an audience of a channel included in the subset in response to selection, by the entity, of a channel included in the subset (e.g., via report component 506).

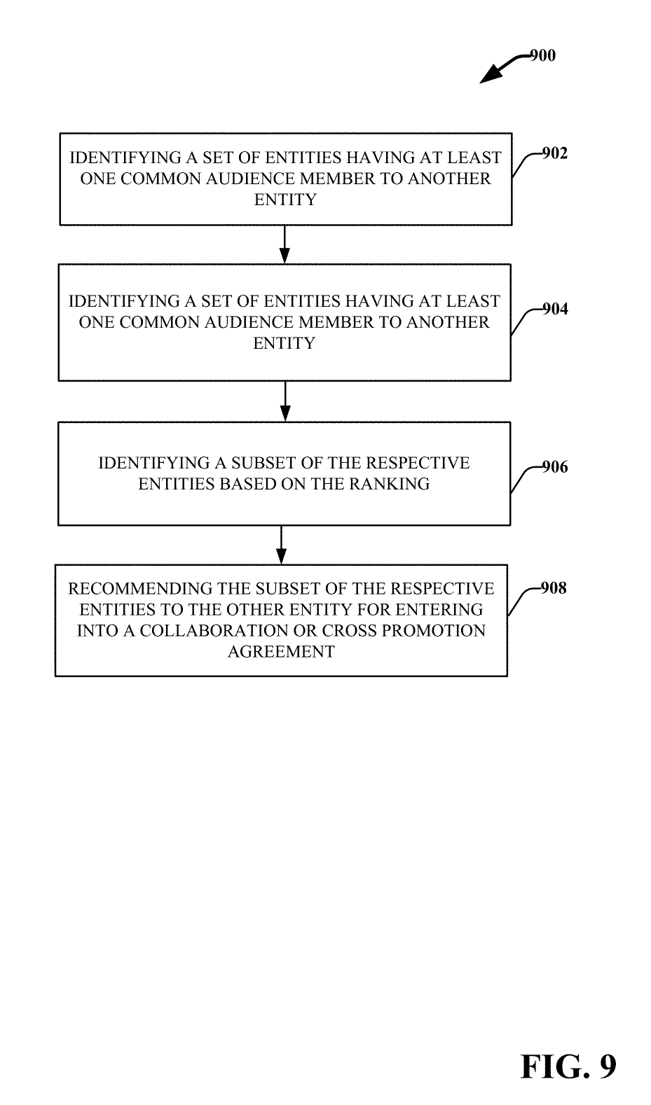

FIG. 9 illustrates a flow chart of another example method 900 that facilitates collaboration between entities based on similarity in respective audiences of the entities, in accordance with various aspects and embodiments described herein. At 902, a set of entities having at least one common audience member to another entity are identified (e.g., via identification component 104). At 904, the respective entities are ranked based on degree of similarity between an audience of the other entity and audiences of the respective entities (e.g., via ranking component 106). At 906, a subset of the respective entities are identified based on the ranking (e.g., via filter component 108). At 908, the subset of the respective entities are recommended to the other entity for entering into a collaboration or cross-promotion agreement (e.g., by recommendation component 110).

With the subject systems and methods, suitable Internet based entities are automatically identified for collaboration/cross-promotion based on metrics that are unique to consumption/usage of an Internet based entity. In particular, channels suitable for cross-promotion/collaboration are automatically identified and recommended to one another based on metrics including but not limited to: amount of common subscribers, total amount of subscribers to the respective channels, amount of common subscribers associated with a specific attribute or class (e.g., demographic, preference, top fan classification, etc.), engagement of the common subscribers with the respective channels (e.g., total watch time, sharing, commenting, etc.), and popularity of the channels. Accordingly, the subject systems and methods do not merely recite the performance of some business practice known from the pre-Internet world along with the requirement to perform it on the Internet. Instead, the claimed mechanisms for identifying and recommending channels for collaboration/cross-promotion with one another is rooted in computer technology in order to overcome a problem specifically arising in the realm of Internet based media systems/networks.

Furthermore, the various features and functionalities of the cross-promotion component 502 and the advertising component 602 tie the various techniques employed by the identification component 104, the ranking component 106 and the filter component 108, used to identify a subset of channels for collaboration/cross-promotion with another channel, to a system's ability (e.g., system 600 and the like via processor 114) to enable private and restricted communication between recommended channels, automatically cross-promote compatible channels, and select and integrate advertisements with channels. By this, the systems and methods provided herein go beyond the mere concept of simply retrieving and combining data using a computer.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

With reference to FIG. 10, a suitable environment 1000 for implementing various aspects of the claimed subject matter includes a computer 1002. The computer 1002 includes a processing unit 1004, a system memory 1006, a codec 1005, and a system bus 1008. The system bus 1008 couples system components including, but not limited to, the system memory 1006 to the processing unit 1004. The processing unit 1004 can be any of various available processors. Dual microprocessors and other multiprocessor architectures also can be employed as the processing unit 1004.

The system bus 1008 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13104), and Small Computer Systems Interface (SCSI).

The system memory 1006 includes volatile memory 1010 and non-volatile memory 1012. The basic input/output system (BIOS), containing the basic routines to transfer information between elements within the computer 1002, such as during start-up, is stored in non-volatile memory 1012. In addition, according to present innovations, codec 1005 may include at least one of an encoder or decoder, wherein the at least one of an encoder or decoder may consist of hardware, a combination of hardware and software, or software. Although, codec 1005 is depicted as a separate component, codec 1005 may be contained within non-volatile memory 1012. By way of illustration, and not limitation, non-volatile memory 1012 can include read only memory (ROM), programmable ROM (PROM), electrically programmable ROM (EPROM), electrically erasable programmable ROM (EEPROM), or flash memory. Volatile memory 1010 includes random access memory (RAM), which acts as external cache memory. According to present aspects, the volatile memory may store the write operation retry logic (not shown in FIG. 10) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1002 may also include removable/non-removable, volatile/non-volatile computer storage medium. FIG. 10 illustrates, for example, disk storage 1014. Disk storage 1014 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1014 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1014 to the system bus 1008, a removable or non-removable interface is typically used, such as interface 1016.

It is to be appreciated that FIG. 10 describes software that acts as an intermediary between users and the basic computer resources described in the suitable operating environment 1000. Such software includes an operating system 1018. Operating system 1018, which can be stored on disk storage 1014, acts to control and allocate resources of the computer system 1002. Applications 1020 take advantage of the management of resources by operating system 1018 through program modules 1024, and program data 1026, such as the boot/shutdown transaction table and the like, stored either in system memory 1006 or on disk storage 1014. It is to be appreciated that the claimed subject matter can be implemented with various operating systems or combinations of operating systems.

A user enters commands or information into the computer 1002 through input device(s) 1028. Input devices 1028 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1004 through the system bus 1008 via interface port(s) 1030. Interface port(s) 1030 include, for example, a serial port, a parallel port, a game port, and a universal serial bus (USB). Output device(s) 1036 use some of the same type of ports as input device(s). Thus, for example, a USB port may be used to provide input to computer 1002, and to output information from computer 1002 to an output device 1036. Output adapter 1034 is provided to illustrate that there are some output devices 1036 like monitors, speakers, and printers, among other output devices 1036, which require special adapters. The output adapters 1034 include, by way of illustration and not limitation, video and sound cards that provide a means of connection between the output device 1036 and the system bus 1008. It should be noted that other devices and/or systems of devices provide both input and output capabilities such as remote computer(s) 1038.

Computer 1002 can operate in a networked environment using logical connections to one or more remote computers, such as remote computer(s) 1038. The remote computer(s) 1038 can be a personal computer, a server, a router, a network PC, a workstation, a microprocessor based appliance, a peer device, a smart phone, a tablet, or other network node, and typically includes many of the elements described relative to computer 1002. For purposes of brevity, only a memory storage device 1040 is illustrated with remote computer(s) 1038. Remote computer(s) 1038 is logically connected to computer 1002 through a network interface 1042 and then connected via communication connection(s) 1044. Network interface 1042 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1044 refers to the hardware/software employed to connect the network interface 1042 to the bus 1008. While communication connection 1044 is shown for illustrative clarity inside computer 1002, it can also be external to computer 1002. The hardware/software necessary for connection to the network interface 1042 includes, for exemplary purposes only, internal and external technologies such as, modems including regular telephone grade modems, cable modems and DSL modems, ISDN adapters, and wired and wireless Ethernet cards, hubs, and routers.

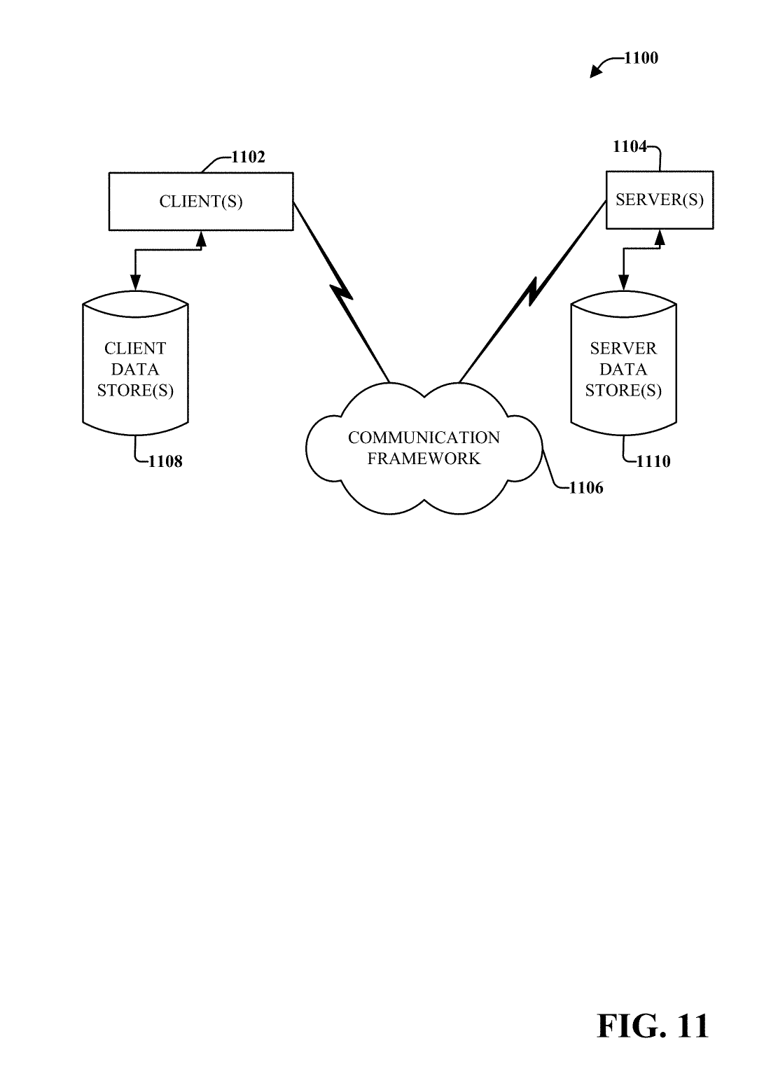

Referring now to FIG. 11, there is illustrated a schematic block diagram of a computing environment 1100 in accordance with this disclosure. The system 1100 includes one or more client(s) 1102 (e.g., laptops, smart phones, PDAs, media players, computers, portable electronic devices, tablets, and the like). The client(s) 1102 can be hardware and/or software (e.g., threads, processes, computing devices). The system 1100 also includes one or more server(s) 1104. The server(s) 1104 can also be hardware or hardware in combination with software (e.g., threads, processes, computing devices). The servers 1104 can house threads to perform transformations by employing aspects of this disclosure, for example. One possible communication between a client 1102 and a server 1104 can be in the form of a data packet transmitted between two or more computer processes wherein the data packet may include video data. The data packet can include a metadata, e.g., associated contextual information, for example. The system 1100 includes a communication framework 1106 (e.g., a global communication network such as the Internet, or mobile network(s)) that can be employed to facilitate communications between the client(s) 1102 and the server(s) 1104.

Communications can be facilitated via a wired (including optical fiber) and/or wireless technology. The client(s) 1102 include or are operatively connected to one or more client data store(s) 1108 that can be employed to store information local to the client(s) 1102 (e.g., associated contextual information). Similarly, the server(s) 1104 are operatively include or are operatively connected to one or more server data store(s) 1110 that can be employed to store information local to the servers 1104.

In one embodiment, a client 1102 can transfer an encoded file, in accordance with the disclosed subject matter, to server 1104. Server 1104 can store the file, decode the file, or transmit the file to another client 1102. It is to be appreciated, that a client 1102 can also transfer uncompressed file to a server 1104 and server 1104 can compress the file in accordance with the disclosed subject matter. Likewise, server 1104 can encode video information and transmit the information via communication framework 1106 to one or more clients 1102.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

1. A system for facilitating cross-promotion between channels hosted by an Internet based media provider, comprising:
a memory that stores computer executable instructions and a data store comprising information identifying the channels and respective subscribers to the channels; and
a hardware processor that, when executing the computer executable instructions stored in the memory, is configured to:
identify, based on information in the data store, a set of the channels respectively having at least one common subscriber to a first channel of the channels;
for each channel in the set of channels, generate a cross-promotion score representative of a degree to which a channel is a match for cross-promotion, wherein the cross-promotion score is based on a number of common subscribers between the channel in the set of channels and the first channel and an engagement score which reflects interaction information with the media content associated with the channel;
rank respective channels in the set based on the cross-promotion score;
identify a subset of channels in the set of channels based on the ranking of the respective channels;
generate a recommendation user interface comprising information identifying the subset of channels as candidates for cross-promotion with the first channel from the set of channels and information associated with the cross-promotion score for each of the channels, wherein the recommendation user interface enables communication with entities associated with each of the subset of channels and restricts communication with entities associated with channels other than the subset of channels; and
cause the recommendation user interface to be presented to an entity affiliated with management of the first channel.

2. The system of claim 1, wherein the hardware processor is further configured to render the recommendation user interface to an entity affiliated with management of the first channel via a graphical user interface associated with access of the first channel via an Internet based platform employed by the Internet based media provider.

3. The system of claim 1, wherein the hardware processor is further configured to:
facilitate communication between the entity affiliated with management of the first channel and respective entities affiliated with management of respective channels in the subset based on inclusion of the respective channels in the subset.

4. The system of claim 3, wherein the hardware processor is further configured to enable communication, via a dedicated messaging platform controlled by the Internet based media provider, between the entity affiliated with management of the first channel and the respective entities affiliated with management of the respective channels in the subset based on inclusion of the respective channels in the subset.

5. The system of claim 3, wherein the hardware processor is further configured to disable communication, via a dedicated messaging platform controlled by the Internet based media provider, between the entity affiliated with management of the first channel and an entity affiliated with management of one of the channels excluded from the subset, based on exclusion of the one of the channels from the subset.

6. The system of claim 1, wherein the hardware processor is further configured to:
generate a report identifying one or more associations between the subscribers to the first channel and subscribers to a channel included in the subset, and provide to the report to the entity affiliated with management of the first channel in response to selection of the channel included in the subset.

7. The system of claim 6, wherein the hardware processor is further configured to render the report to the entity affiliated with management of the first channel via a graphical user interface associated with access of the first channel via the Internet based platform employed by the Internet based media provider.

8. The system of claim 1, wherein the hardware processor is further configured to:
include first content on respective channels included in the subset that promotes the first channel in response to inclusion of the respective channels in the subset.

9. The system of claim 8, wherein the hardware processor is further configured to include second content on the first channel that promotes a channel included in the subset in response to inclusion of the channel in the subset.

10. The system of claim 1, wherein the hardware processor is further configured to:
include first content on a channel included in the subset that promotes the first channel, and second content on the first channel that promotes the channel included in the subset, based on inclusion of the channel in the subset and in response to authorization information provided by the entity affiliated with management of the first channel and an entity affiliated with management of the channel included in the subset.

11. The system of claim 1, wherein the hardware processor is further configured to rank the respective channels in the set based on total number of subscribers to the respective channels and total number of subscribers to the first channel.

12. The system of claim 1, wherein the hardware processor is further configured to identify the subset of the respective channels based on the number of common subscribers between the respective channels in the set and the first channel exceeding a threshold value.

13. The system of claim 1, wherein the hardware processor is further configured to identify the subset of the respective channels based on a ratio of number of subscribers to the first channel and number of subscribers to respective channels in the subset exceeding a threshold value.

14. The system of claim 1, wherein the hardware processor is further configured to identify the subset of the respective channels based on number of the common subscribers between the respective channels and the first channel that are associated with a particular attribute or classification.

15. The system of claim 1, wherein the hardware processor is further configured to rank the respective channels in the set based on a total amount of time, the common subscribers to the first channel and the respective channels, played media respectively included in the respective channels of the set.

16. A method for facilitating cross-promotion between channels hosted by an Internet based media provider, comprising:
storing information identifying the channels and respective subscribers to the channels in a data store; and
using a hardware processor to execute the following computer executable instructions stored in a memory to perform the following acts:
identifying a set of the channels having at least one common subscriber to a first channel of the channels based on the information in the data store;
for each channel in the set of channels, generating a cross-promotion score representative of a degree to which a channel is a match for cross-promotion, wherein the cross-promotion score is based on a number of common subscribers between the channel in the set of channels and the first channel and an engagement score which reflects interaction information with the media content associated with the channel;
ranking respective channels in the set based on the cross-promotion score;
identifying a subset of channels in the set of channels based on the ranking of the respective channels;
generating a recommendation user interface comprising information identifying the subset of channels as candidates for cross-promotion with the first channel from the set of channels and information associated with the cross-promotion score for each of the channels, wherein the recommendation user interface enables communication with entities associated with each of the subset of channels and restricts communication with entities associated with channels other than the subset of channels; and
causing the recommendation user interface to be presented to an entity affiliated with management of the first channel.

17. The method of claim 16, further comprising:
enabling communication, via a dedicated messaging platform controlled by the Internet based media provider, between the entity affiliated with management of the first channel and the respective entities affiliated with management of the respective channels in the subset based on inclusion of the respective channels in the subset.

18. The method of claim 16, further comprising:
prohibiting communication, via a dedicated messaging platform controlled by the Internet based media provider, between the entity affiliated with management of the first channel and an entity affiliated with management of one of the channels excluded from the subset, based on exclusion of the one of the channels from the subset.

19. A non-transitory computer-readable storage medium comprising computer-readable instructions that, in response to execution, cause an Internet based media system to perform operations, comprising:
identifying a set of channels hosted by the Internet based media system having at least one common subscriber to another channel hosted by the Internet based media system;
for each channel in the set of channels, generating a cross-promotion score representative of a degree to which a channel is a match for cross-promotion, wherein the cross-promotion score is based on a number of common subscribers between the channel in the set of channels and the first channel and an engagement score which reflects interaction information with the media content associated with the channel;
ranking respective channels in the set based on the cross-promotion score;
identifying a subset of channels in the set of channels based on the ranking of the respective channels;
generating a recommendation user interface comprising information identifying the subset of channels as candidates for cross-promotion with the first channel from the set of channels and information associated with the cross-promotion score for each of the channels, wherein the recommendation user interface enables communication with entities associated with each of the subset of channels and restricts communication with entities associated with channels other than the subset of channels; and the other channel; and
causing the recommendation user interface to be presented to an entity affiliated with management of the first channel.

20. The non-transitory computer-readable storage medium of claim 19, further comprising:
providing first content on at least one channel included in the subset that advertises the first channel in response to inclusion of the at least one channel in the subset.
